(19) United States
(12) Patent Application Publication
(10) Pub. No.: US 2018/0106144 A1
(43) Pub. Date: Apr. 19, 2018

(54) Pinpointing Water Producing Zone During Multizone Production

(71) Applicant: Meduna Investments, LLC, Cypress, TX (US)

(72) Inventor: Albert E. Hyde, JR., Houston, TX (US)

(73) Assignee: Meduna Investments, LLC, Cypress, TX (US)

(21) Appl. No.: 15/294,513

(22) Filed: Oct. 14, 2016

(51) Int. Cl. E21B 47/10; C09K 8/80; E21B 43/267; E21B 34/10; E21B 43/14

(52) U.S. Cl. CPC E21B 47/1015; C09K 8/805; E21B 2034/007; E21B 34/10; E21B 43/14; E21B 43/267

(57) ABSTRACT

Different zones are fractured with proppant containing tracer dye of different colors that is encapsulated in the proppant. The presence of an undesired material such as water removes the coating to allow the uniquely colored tracer dye to be released during production. Surface personnel note the color of the dye and associate a specific zone that is producing the undesired material. Steps are taken to close off the offending zone as production continues from the other zones in the borehole.

### FIELD OF THE INVENTION

The field of the invention is determination of which of several producing zones is producing water when multiple zones are on production at the same time so that the water producing zone can be isolated and more particularly using tracers to pinpoint the water producing zone.

### BACKGROUND OF THE INVENTION

Frequently when a well is completed there are perforations in multiple zones in a single formation or discrete zones in spaced apart formations that are created. The formations may be put on production one at a time or at the same time. At some point in time the well can start to produce undesirable materials such as water. When that happens the response is frequently isolation of such a zone to redirect production from other zones that do not have this issue. At times it is challenging to pinpoint exactly where the water is coming from. Sometimes water migrates through the formation and it is produced at a different access point in the wellbore. It would be desirable to be able to pinpoint the source of water production to be able to close off the right zone or zones in the formation.

Part of well completion can be hydraulic fracturing where fluid and solids are pumped at high pressure into the formation to fracture the formation to enhance subsequent production. The fracture fluid under pressure creates the fractures that are then propped open by the solids contained in the fracture fluid stream. Typically these solids are called proppants and are frequently at least in part sand.

Tracer fluids are used during production to aid analysis of the nature of the fluids being produced as a way to determine if the produced fluids are the fluids expected from the producing formations. Some examples of dye tracers are U.S. Pat. No. 6,729,400; 7,028,773; 6,564,866; 8,141,633; 6,016,191; 7,347,260 and 7,658,226.

The present invention uses tracers that are of recognizable different colors in different zones and preferably embeds the tracer in coated proppants. If the undesired fluid is produced in a specific zone, the coating on the tracer is removed to let the tracer escape to the surface. Since each zone is fractured with different color tracer, surface personnel can pinpoint the specific zone that is producing the undesired fluid and steps can be taken to close that zone off

These and other advantages of the present invention will become apparent from the following description and drawings. Those skilled in the art will further appreciate other aspects of the invention from a review of the detailed description of the preferred embodiment and the associated drawings while understanding that the full scope of the invention can be determined by the appended claims.

### SUMMARY OF THE INVENTION

Different zones are fractured with proppant containing tracer dye of different colors that is encapsulated in the proppant. The presence of an undesired material such as water removes the coating to allow the uniquely colored tracer dye to be released during production. Surface personnel note the color of the dye and associate a specific zone that is producing the undesired material. Steps are taken to close off the offending zone as production continues from the other zones in the borehole. Detection of cross flow between zones can also be accomplished if the same color is still produced after the zone associated with its color is isolated.

### BRIEF DESCRIPTION OF THE DRAWINGS

For a detailed description of the preferred embodiment of the invention, reference will now be made to the accompanying drawings wherein:

FIG. 1 shows a two zone completion that has been perforated and fractured with tracer dye of different colors encapsulated in the proppant of the illustrated zones;

FIG. 2 is the view of FIG. 1 showing the production of an undesired material in one of the zones releasing the tracer dye; and

FIG. 3 is the view of FIG. 2 where the zone producing the tracer dye is cut off while the other zone with the tracer dye of a different color continues to produce while maintaining its tracer dye encapsulated.

### DETAILED DESCRIPTION OF THE PREFERRED EMBODIMENT

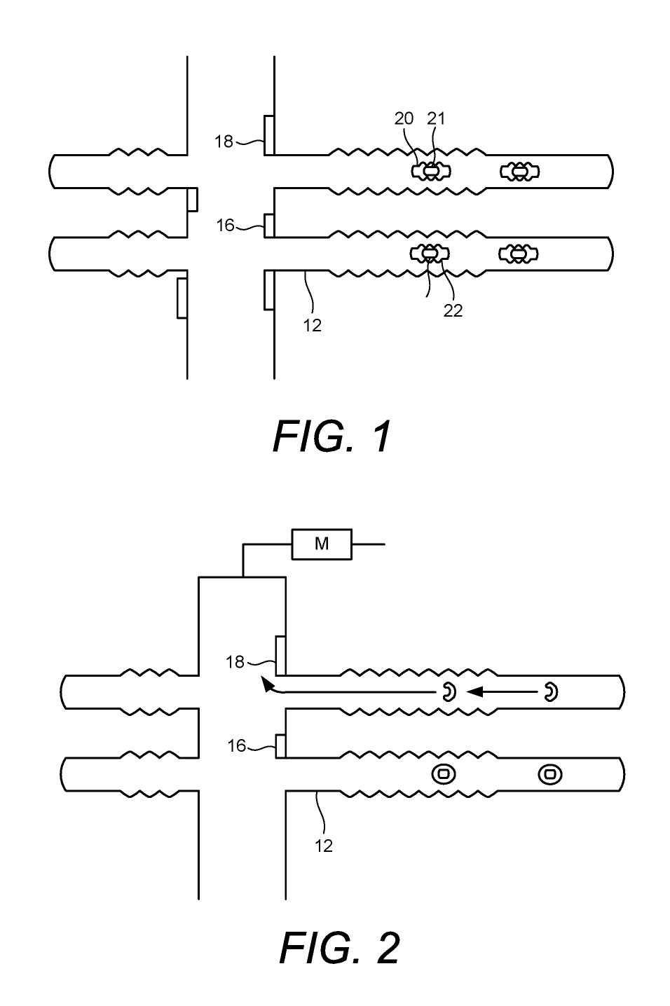

FIG. 1 illustrates two perforated and fractured zones 10 and 12 in a borehole 14. Isolation valves 16 and 18 respectively are used to selectively isolate zones 10 or 12 should there be an indication that either of those zones are producing an undesired material such as water. Zone 10 has schematically illustrated proppant 20 from fracturing with encapsulated dye 21 having a unique color while zone 12 has schematically illustrated proppant 22 with tracer dye 23 encapsulated therein. The color of dye 23 is recognizably different than the color of dye 21.

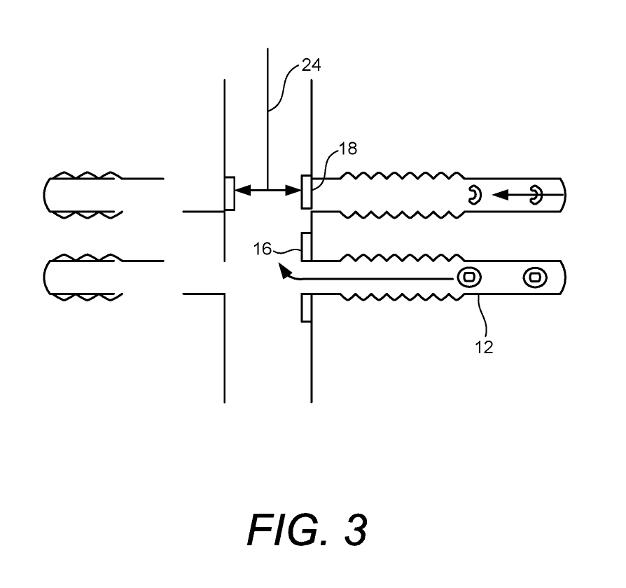

It should be noted that while only two zones are illustrated to explain the concept, that multiple zones each with a unique color of tracer dye can be used. Furthermore, the proppant 20 or 22 can form only a portion of the proppant pumped under pressure into a respective zone. The zone needs to have its fractures held open even when the undesirable material is being produced so only some of the proppant can carry the dye tracer while the remaining proppant can be of a type or types that are well known in the art. While 20 or 22 can be actual proppant, it can also be simply tracer dye encapsulated for containment without serving a proppant function at all. In this case the presence of unwanted material being produced such as water will remove, dissolve or otherwise disable the coating allowing the tracer dye to be released to flow to the surface. A meter M can be used to take continuous or periodic readings on the produced fluid to spot the presence on the tracer dye in the produced fluid. Such a meter can be a spectrometer that can discern the different colors of the dye in the produced fluid so that the location of the production of the undesired material, such as water, can be determined and the needed valve such as 16 or 18 can be closed off with a wireline or coiled tubing mounted shifting tool schematically illustrated as 24. As shown in FIG. 3 the zone 12 continues to produce with its uniquely colored tracer dye 23 still encapsulated. Should zone 12 continue to produce the dye color associated with zone 10 after zone 10 is isolated, then surface personnel have a signal that there is water or other undesired material flow going from zone 10 into zone 12 and zone 12 may also need to be isolated and production continue from other zones, not shown to avoid the unwanted production of water or other material to the surface. Valve 18 is closed either with intervention as described above or without intervention such as by dropping a uniquely sized ball on a seat associated with each valve and pushing the valve to a closed and locked position with the ball either blown through the seat or produced to the surface with subsequent production. The valves can also have local operators that can be remotely signaled to close once a tracer dye of a particular color is detected. While the tracer material detection property can be a detectable color other properties can be employed to foster the association between the production or water or other undesired material and the precise zone that is producing the material. Some example of detectible properties can be viscosity, density or dielectric constant to name a few.

Those skilled in the art will now be able to appreciate that the method of the present invention allows the location of production of unwanted water or other materials to be pinpointed in a multizone borehole so that a particular zone can be isolated promptly. Sometimes water can migrate from one zone to an adjacent zone so that more than one zone may need to be closed off before there is no longer an indication of the dye tracer. The method can be used to detect migration of water or other materials from an injection well into a production well or other applications.

The above description is illustrative of the preferred embodiment and many modifications may be made by those skilled in the art without departing from the invention whose scope is to be determined from the literal and equivalent scope of the claims below:

What is claimed is:

1. A method to locate a zone producing an undesired material from a multi-zone well, comprising:
delivering encapsulated unique materials into at least two zones;
configuring the encapsulation to release said unique material in a zone where an undesired material is present;
detecting the presence of a unique material; and
shutting off at least the zone associated with the unique material detected.

2. The method of claim 1 further including the step of releasing said unique material in the presence of water.

3. The method of claim 1 further including the step of removing the encapsulating material by dissolving, disintegrating or otherwise failing in the presence of said undesired material.

4. The method of claim 1 further including the step of using dye of different color in each zone as the unique material.

5. The method of claim 1 further including the step of using a different unique material in each zone that has a different measurable physical property.

6. The method of claim 5 further including the step of using viscosity, density or dielectric constant as the measurable physical property.

7. The method of claim 1 further including the step of performing said shutting off without well intervention.

8. The method of claim 1 further including the step of performing said shutting off with well intervention.

9. The method of claim 8 further including the step of providing wireline, slickline, or coiled tubing for said shutting off

10. The method of claim 1 further including the step of performing said delivering with proppant used to fracture each zone.

11. The method of claim 10 further including the step of making at least some of the delivered proppant contain encapsulated unique material.

12. The method of claim 1 further including the step of recognizing which zone to isolate based on a measured property of said unique material.

13. The method of claim 1 further including the step of performing said shutting off with at least one sliding sleeve valve selectively operable with or without wellbore intervention.

14. The method of claim 13 further including the step of using at least one dropped ball to land on a conforming seat in said sliding sleeve to shift the sliding sleeve to closed position.

15. The method of claim 2 further including the step of removing the encapsulating material by dissolving, disintegrating or otherwise failing in the presence of said undesired material.

16. The method of claim 15 further including the step of using dye of different color in each zone as the unique material.

17. The method of claim 15 further including the step of using a different unique material in each zone that has a different measurable physical property.

18. The method of claim 17 further including the step of using viscosity, density or dielectric constant as the measurable physical property.

19. The method of claim 17 further including the step of performing said delivering with proppant used to fracture each zone.

20. The method of claim 19 further including the step of making at least some of the delivered proppant contain encapsulated unique material.

21. The method of claim 1 further including the steps of:
still detecting the presence of said unique material after said shutting off the zone exclusively associated with the produced unique material;
recognizing that the undesired material is migrating to an adjacent zone by virtue of said still detecting; and
closing off at least one additional zone to prevent producing the undesired material.

22. The method of claim 21 further including the step of closing off the adjacent zone as said additional zone.
